(19) United States
(12) Patent Application Publication
(10) Pub. No.: US 2006/0002390 A1
(43) Pub. Date: Jan. 5, 2006

(54) Method and apparatus for storing and searching broadcasting stream

(75) Inventors: Jong-hoon Jeong, Suwon-si (KR); Sun-hee Youm, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/171,273

(22) Filed: Jul. 1, 2005

(30) Foreign Application Priority Data
Jul. 1, 2004 (KR) 10-2004-0051006

(51) Int. Cl. H04L 12/28

(52) U.S. Cl. 370/389

(57) ABSTRACT

A method and apparatus for storing and searching a broadcasting stream, the method having operations of: storing a broadcasting stream received during a predetermined period; extracting information from the received broadcasting stream indicating a content of the received broadcasting stream; constructing a database based on the extracted information; displaying the information indicating the content of the stored broadcasting stream based on the database; and searching a broadcasting stream corresponding to select information from the stored broadcasting stream when the select information, selected on the basis of the information to be displayed, is received, wherein the database includes link information about the stored broadcasting stream.

### CROSS-REFERENCE TO RELATED APPLICATIONS

This application claims the priority of Korean Patent Application No. 10-2004-0051006, filed on Jul. 1, 2004, in the Korean Intellectual Property Office, the disclosure of which is incorporated herein in its entirety by reference.

### BACKGROUND OF THE INVENTION

1. Field of the Invention

The present invention relates to digital broadcasting and, more particularly, to a method of and an apparatus for storing a broadcasting stream received by a digital broadcasting receiver, and searching the stored broadcasting stream.

2. Description of the Related Art

Digital broadcasting allows high quality audio, video, graphics, and various additional information to be transmitted. Multimedia services, which the digital broadcasting is able to provide, include a travel and traffic information service, an information service interworking with a program capable of combining headline letters with images or traffic information with an electronic map, an independent information service having no connection with website broadcasting or a program such as a GPS (global positioning system) for digital broadcasting, and a moving picture transmission service.

A digital broadcasting receiver receives a digital broadcasting stream through a wire/wireless channel, stores the received stream in a storage medium, and plays and manages the broadcasting stream stored in the storage medium. A conventional digital broadcasting receiver designates a storage path and file name of a received digital broadcasting stream and stores the digital broadcasting stream according to rules predetermined by a manufacturer, to efficiently play and manage the digital broadcasting stream stored in a storage medium. But since the storage path and the file name are set without considering the content of the received broadcasting stream, the content of the broadcasting stream cannot be identified based on the storage path and the file name. Hence, it is difficult to manage and search the broadcasting stream that is stored according to the conventional method.

While a user may be requested to designate the storage path and file name of the broadcasting stream to be stored, if a user is using an input device, such as a remote controller, with which alpha-numeric character entry is difficult, it is hard for the user to input the storage path and file name in a digital broadcasting receiver.

Alternatively, the storage path and file name of the received broadcasting stream may be designated and stored using broadcasting information received through an additional channel or a network path. But an additional channel must then be secured. Thus, it is difficult to set the storage path and file name of the broadcasting stream in a mobile digital broadcasting receiver in which it is difficult to secure an additional network connection path.

### SUMMARY OF THE INVENTION

Additional aspects and/or advantages of the invention will be set forth in part in the description which follows, and in part, will be apparent from the description, or may be learned by practice of the invention.

The present invention provides a method of and an apparatus for storing a digital broadcasting stream using service information indicating a content included in the digital broadcasting stream received by a digital broadcasting receiver, and searching the stored broadcasting stream.

The present invention also provides a method of and an apparatus for constructing a database for storing a digital broadcasting stream with information indicating a content included in the digital broadcasting stream received by a digital broadcasting receiver, and searching the digital broadcasting stream using the constructed database.

According to an aspect of the present invention, there is provided a method of storing a broadcasting stream, having operations of: storing a broadcasting stream received during a predetermined period; extracting information indicating a content of the received broadcasting stream from the received broadcasting stream; and constructing a database based on the extracted information, wherein the database includes link information about the stored broadcasting stream.

According to one aspect, the information indicating the content of the broadcasting stream is extracted from a high-speed information channel of transmission frames of the received broadcasting stream.

According to one aspect, link information has at least one of a storage path, file name, storage date, or storage location of the broadcasting stream.

According to one aspect, information indicating the content includes at least one of ensemble information, sub channel configuration, basic service and service component configuration, service component language, or a data service label, and the database has a hierarchical data structure based on the information indicating the content.

According to one aspect, the method additionally has operations of checking whether the extracted information indicating the content is effective and constructing the database when the information indicating the content is recognized to be effective.

According to one aspect, the method additionally has operations of attempting to extract the information indicating the content of the broadcasting stream until reaching a predetermined number of attempts or until a predetermined time elapses, and if the predetermined number of attempts is reached or the predetermined time elapses, the information indicating the content of the broadcasting stream is determined to not be effective.

According to another aspect of the present invention, there is provided a method of storing and searching a broadcasting stream in a broadcasting receiver, the method having operations of: storing a broadcasting stream during a predetermined period; extracting information indicating a content of the received broadcasting stream from the received broadcasting stream; constructing a database based on the extracted information; displaying the information indicating the content of the stored broadcasting stream based on the database; and searching a broadcasting stream corresponding to select information from the stored broadcasting stream when the select information, selected on the basis of the information to be displayed, is received, wherein the database includes link information about the stored broadcasting stream.

According to one aspect, the information indicating the content of the stored broadcasting stream is displayed as a hierarchical data structure based on at least one of a broadcasting type, a storage date, a broadcasting title, a broadcasting station, or a size of the stored data.

According to still another aspect of the present invention, there is provided an apparatus for storing and searching a broadcasting stream in a broadcasting receiver, the apparatus having: an information extracting unit extracting information from a received broadcasting stream indicating a content of the received broadcasting stream; a database constructing and searching unit constructing a database based on the extracted information indicating the content of the received broadcasting stream, and searching the constructed database; a storage medium storing the received broadcasting stream and the constructed database; and a control unit controlling the constructed database to be stored in the storage medium, controlling the information indicating the content of the broadcasting stream stored in the storage medium to be output based on the database that the database constructing and searching unit searches from the storage medium, and when a searching request signal is received, searching a broadcasting stream corresponding to the received searching request signal from the storage medium, wherein the database includes link information about the broadcasting stream stored in the storage medium.

According to one aspect, the information-extracting unit extracts the information indicating the content of the broadcasting stream from a high-speed information channel of the received broadcasting stream.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a functional block diagram of a digital broadcasting receiver including broadcasting stream storing and searching apparatus according to an embodiment of the present invention;

FIG. 2 is a structure diagram of a transmission frame of a general digital broadcasting stream;

FIG. 3 is a structure diagram of an FIB (fast information block) illustrated in FIG. 2;

FIG. 4 shows an example of constructing a database, and a diagram showing a relationship between the constructed database and storage media;

FIG. 5 is a flowchart of a method of storing a broadcasting stream according to an embodiment of the present invention; and

FIG. 6 is a flowchart of a method of searching a broadcasting stream according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described to explain the present invention by referring to the figures.

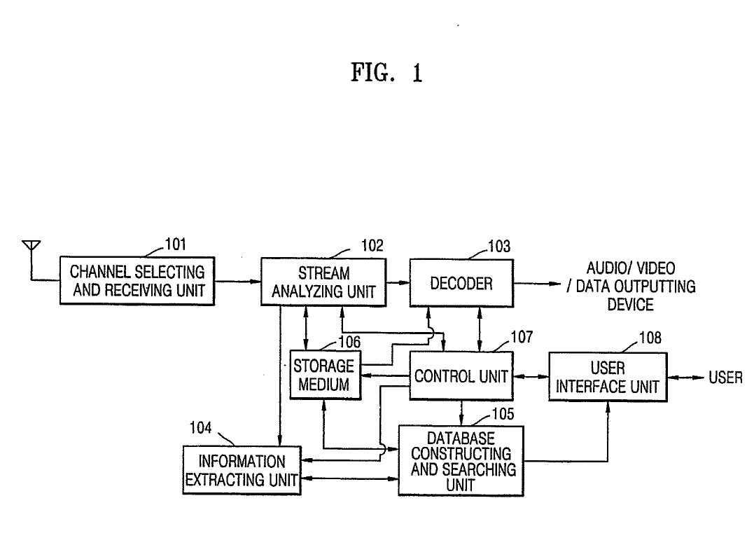

FIG. 1 is a functional block diagram of a digital broadcasting receiver including broadcasting stream storing and searching apparatus according to an embodiment of the present invention. Referring to FIG. 1, the digital broadcasting receiver includes a channel selecting and receiving unit 101, a stream analyzing unit 102, a decoder 103, an information extracting unit 104, a database constructing and searching unit 105, a storage medium 106, a control unit 107, and a user interface unit 108.

The channel selecting and receiving unit 101 extracts a digital broadcasting signal of a channel selected by a user from a digital broadcasting signal received through a wire/wireless channel, and outputs a demodulated broadcasting stream by demodulating the extracted digital broadcasting signal and removing a carrier wave therefrom.

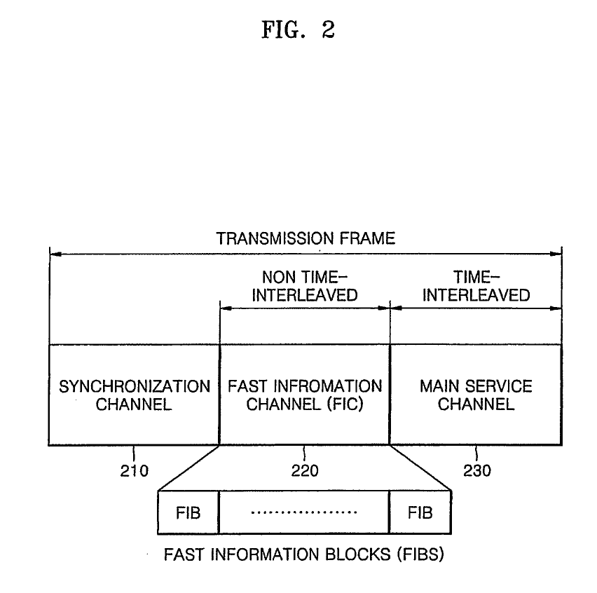

The stream analyzing unit 102 classifies the received broadcasting stream according to channels and media when receiving the broadcasting stream of the selected channel from the channel selecting and receiving unit 101. FIG. 2 shows a structure of a transmission frame of the received digital broadcasting stream. Referring to FIG. 2, the digital broadcasting stream includes a synchronization channel (SC) 210, a fast information channel (FIC) 220, and a main service channel (MSC) 230.

According to one embodiment, the SC 210 includes a null symbol, which can determine a transmission mode, and a reference symbol, which is required for a carrier wave frequency synchronization.

The FIC 220 is used to transfer pieces of information necessary for the digital broadcasting receiver to process data, for example, information about a service configuration or multiplied types of data, or data necessary to be fast transmitted. The FIC 220 may include multiplex configuration information (MCI) including information of the each sub channel's configuration, and service information (SI) that is additional information of each service. Accordingly, by identifying the FIC 220, a service of which data is transmitted through the MSC 230 can be recognized. Also, it can be determined which application will use the service. In particular, the SI may include information indicating a content of a received broadcasting stream. The FIC 220 may include data which should be transmitted quickly within a fixed time. For example, a simple message about an emergency can be transmitted through the FIC 220. The FIC 220 is composed of fast information blocks (FIBs) as shown in FIG. 2.

The MSC 230 transmits actual content data which a service provider supplies. That is, the MSC 230 transmits audio, video, and data information. Further, when the FIC 220 is short of space, the MSC 230 can share a part of FIC data, but cannot include the FIC data which should be quickly transmitted, because the MSC 230 is applied with time interleaving and thus, takes a little time to be decoded. The actual content data transmitted through the MSC 230 can be divided according to a data transmission mode. The data transmission mode may be a stream mode or a packet mode.

Accordingly, the stream analyzing unit 102 transfers the FIC 220 of the received broadcasting stream to the information-extracting unit 104, classifies the MSC 230 according to the media, and transfers the classified MSC 230 to the decoder 103. The media may include audio, video, and/or data information.

The decoder 103 restores the audio, video and data information transferred from the stream analyzing unit 102 to their former states before coding. The restored audio, video and data information is transmitted to corresponding output devices (not shown), respectively. The output devices may include a monitor or a speaker. Accordingly, the user can watch/listen to the selected digital broadcasting through the corresponding output device. According to one embodiment, the decoder 103 includes decoders corresponding to the audio, video, and data information respectively transferred from the stream analyzing unit 102.

The information extracting unit 104 extracts service information of the currently stored broadcasting stream by analyzing the FIC 220 stream received from the stream analyzing unit 102. The service information includes information indicating the content of the broadcasting stream.

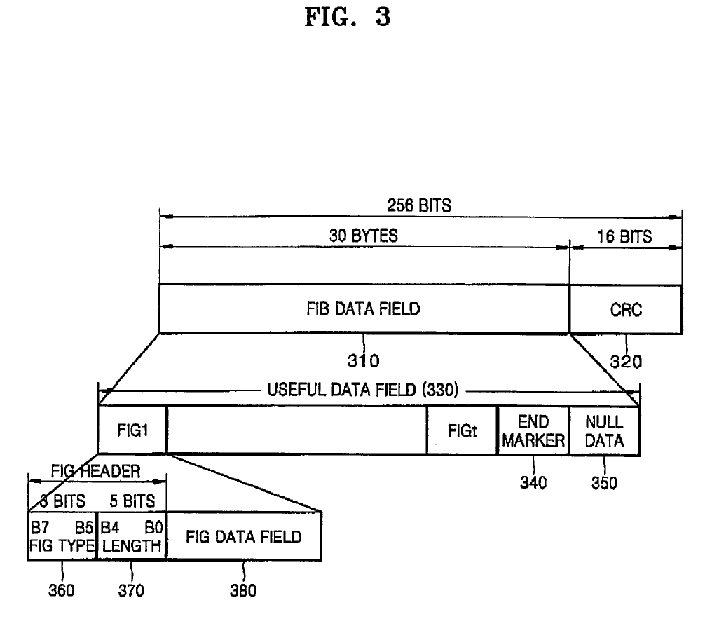

The FIC 220 stream transferred from the stream analyzing unit 102 is composed of the FIBs as shown in FIG. 2. The FIB is composed as shown in FIG. 3.

FIG. 3 is a structure diagram of the FIB. The FIB is composed of an FIB data field 310 and a CRC (cyclic redundancy check code) field 320. The information extracting unit 104 checks whether the extracted service information is effective (valid) based on data transmitted through the CRC field. That is, the information-extracting unit 104 checks if the information indicating the content of the broadcasting stream is effective.

The FIB data field 310 is 30 bytes, and includes FIGs (fast information groups), particularly FIG1˜FIGt. If the FIB data field 310 is not filled with the FIGs, an end marker 340 indicating the end of the FIG data and null data are padded 350 to form a 256-bit FIB. An FIG type field 360 indicating a type of data included in the FIG data field 380 and a length field 370 indicating a length of the FIG data field 380 are inserted in a header, and then the actual data is stored in the FIG data field 380. The information about an FIG type or the syntax of data varies according to an application to be used or information to be indicated.

The information to be included in the FIG type field 360 and FIG data field 380 can be defined as shown in Table 1.

TABLE 1

| FIG type | Content |
|---|---|
| 0/0 | Ensemble information |
| 0/1 | Sub channel configuration |
| 0/2 | Basic service and service component configuring |
| 0/5 | Service component language |
| 1/5 | Data service label |

The ensemble information of Table 1 is broadcasting stream provider information. For example, the ensemble information includes information about a broadcasting station such as KBS (Korea Broadcasting System), MBC (Munhwa Broadcasting Company) and SBS (Seoul Broadcasting System). The sub channel configuration is information about a type of broadcasting that indicates the broadcasting stream is a sport, news, a drama, home shopping, or others. The basic service and service component configuration is information which indicates a detailed type of broadcasting. For example, if the broadcasting is sports, the basic service and service component configuration indicates that the sport is, for example, baseball or soccer. The service component language is broadcasting language information which indicates the language used in the broadcasting stream is, for instance, Korean or English. The data service label is a broadcasting title of the broadcasting stream.

Therefore, the information indicating a content of a broadcasting stream can include the ensemble information, the sub channel configuration, the basic service and service component configuration, the service component language, and the data service label. The information extracting unit 104 extracts the information indicating a content of a broadcasting stream transmitted through the FIG data field 380. The extracted information is transmitted to the database constructing and searching unit 105.

The database constructing and searching unit 105 constructs a database of the broadcasting stream to be stored in the storage medium 106 based on the information indicating the content of the broadcasting stream that is provided from the information extracting unit 104.

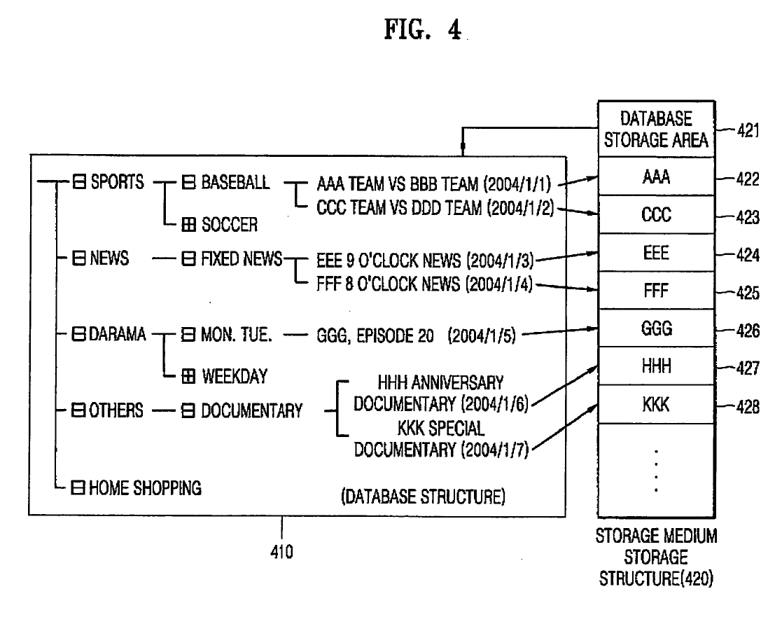

That is, the database is constructed to have a hierarchical data structure based on the information indicating the content of the broadcasting stream to be stored in the storage medium 106, as shown in 410 of FIG. 4. The numeral 410 of FIG. 4 indicates a database in which a plurality of broadcasting streams stored in the storage medium 106 are classified according to a broadcasting type, such as sport, news, drama, home shopping, etc. But the database can be constructed with a hierarchical data structure based on storage date, a broadcasting title, a broadcasting station, or a size of stored data.

Further, the database 410 includes link information of the broadcasting stream stored in the storage medium 106. Specifically, the database 410 includes a storage path, file name, storage date, and storage location of the broadcasting stream stored in the storage medium 106. For example, with respect to a baseball game between AAA team and BBB team, the database 410 may include link information in which storage path information is specified as “sports/baseball”, a file name is “AAA team Vs BBB team”, the storage date is Jan. 1, 2004 (2004/1/1), and the storage location in the storage medium 106 is defined as AAA 422.

The constructed database 410 is stored in a database storage area 421 in a storage structure 420 of the storage medium 106 as shown in FIG. 4. The broadcasting stream is randomly stored in an empty storage area of the storage medium 106.

When a user intends to search the stored broadcasting stream, the database constructing and searching unit 105 searches the database stored in the storage medium 106 and transmits database information to the user interface unit 108. At this moment, the database constructing and searching unit 105 can output the database information being controlled by a control unit 107 in a hierarchical data structure that is based on the information indicating a content of the broadcasting stream.

For example, the database constructing and searching unit 105 can output the information indicating a content of the broadcasting stream in a hierarchical data structure 410 based on the broadcasting type as shown in FIG. 4. Otherwise, the database constructing and searching unit 105 can output the information indicating the content of the broadcasting stream with a hierarchical data structure based on the storage date, a size of the stored data, a broadcasting title, or a broadcasting station.

As shown in FIG. 4, the user can identify that the storage path of the baseball game between the AAA team and the BBB team is /sports/baseball/AAA team Vs BBB team, and that a baseball game between CCC team and DDD team, 9 o'clock news of EEE broadcasting station, 8 o'clock news of FFF broadcasting station, episode No. 20 of a drama titled ‘GGG’, an HHH anniversary documentary and a KKK special documentary are included in the storage medium 106.

When the control unit 107 receives various signals through the user interface unit 108, the control unit 107 controls every component of the digital broadcasting receiver. In particular, when a request signal of storing the broadcasting stream is received from the user interface unit 108, the control unit 107 controls the stream analyzing unit 102 to store the intended broadcasting stream in the storage medium 106, controls the information extracting unit 104 and the database constructing and searching unit 105 to construct the database for the broadcasting stream stored in the storage medium 106, and stores the constructed database in the storage medium 106.

Meanwhile, when a request signal for searching the broadcasting stream stored in the storage medium 106 is received from the user interface unit 108, the control unit 107 controls the storage medium 106 and the database constructing and searching unit 105 to search the database information stored in the storage medium 106, and transfers the searched database information to the user interface unit 108. At this moment, the control unit 107 can control the database constructing and searching unit 105 such that the searched database information is transferred to the hierarchical data structure as previously described. The request signal of searching is generated when a user requests to play or manage the broadcasting stream stored in the storage medium 106.

The user interface unit 108 receives various instructions (or various signals) that a user intends to input, provides the instructions to the control unit 107, and provides the information received from the control unit 107 or from the database constructing and searching unit 105 to the user. The various instructions the user can input may include a power on/off, channel set, sound volume set, request of storing the received broadcasting stream, and an instruction for request of searching the stored broadcasting stream. The search request instruction may be generated during playing or managing the stored broadcasting stream. Additionally, the information received from the database constructing and searching unit 105 is database information constructed according to an embodiment of the present invention, which indicates the content of the stored broadcasting stream.

The storage medium 106 can store the constructed database information and the broadcasting stream that the user intends to store with the structure as shown in 420 of FIG. 4.

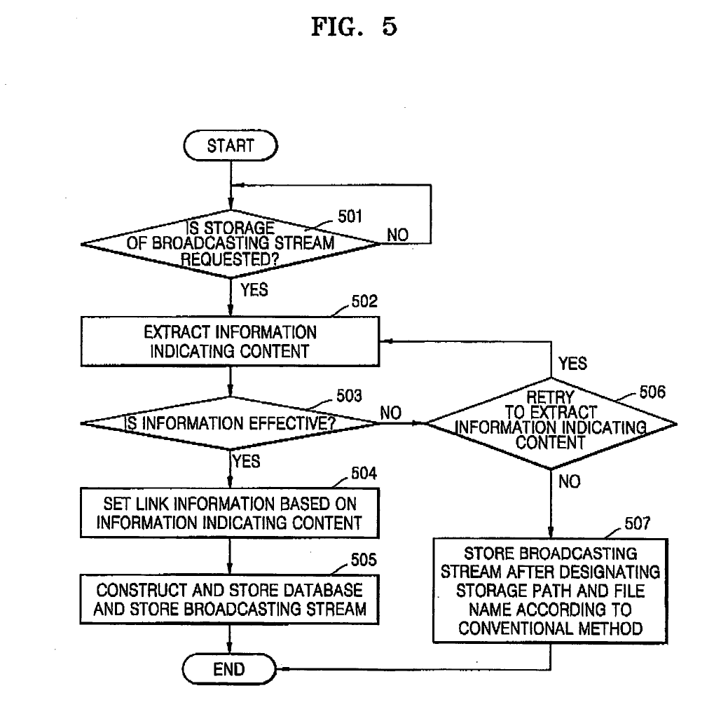

FIG. 5 is a flowchart of a method of storing a broadcasting stream according to an embodiment of the present invention.

Referring to FIG. 5, when a user requests to store a received broadcasting stream (operation 501), the control unit 107 controls an operation of the digital broadcasting receiver to extract information indicating the content of the received broadcasting stream (operation 502). The information indicating a content of the received broadcasting stream is extracted from the FIC 220 illustrated in FIG. 2. The extracted information indicating the content may include ensemble information, sub channel configuration, basic service and service component configuration, service component language, and/or a data service label as shown in Table 1.

It is checked whether the extracted information indicating the content is effective (operation 503). Specifically, it is checked whether the extracted information indicating the content is effective based on the information transferred through the CRC field illustrated in FIG. 3. If the extracted information is determined to be effective, link information, such as storage path and file name, of the broadcasting stream to be stored are set based on the extracted information indicating the content (operation 504). For example, with respect to the baseball game between AAA team and BBB team shown in FIG. 4, the storage path of the broadcasting stream of the baseball game is designated as “/sports/baseball/”, and the file name of the broadcasting stream is designated as “AAA team Vs BBB team”. At this moment, the storage date and the storage location can be also designated together.

Next, a database including the set link information is constructed as the database structure 410 illustrated in FIG. 4. The constructed database, which is based on the information indicating the content of the stored broadcasting stream, has a hierarchical data structure. The constructed database and the broadcasting stream to be received are stored in the storage medium 106 (operation 505).

In operation 503, if the extracted information indicating the content is determined not to be effective, it is determined whether to retry to extract the information indicating the content (operation 506). If the number of times when the information indicating the content failed to be extracted does not reach a predetermined number of times, or a time associated therewith does not reach a predetermined time, the method returns to the operation 502 and another attempt to extract the information indicating the content is performed. In the opposite case, the storage path and file name of the broadcasting stream are set according to one of the conventional methods, and the broadcasting stream is stored (operation 507).

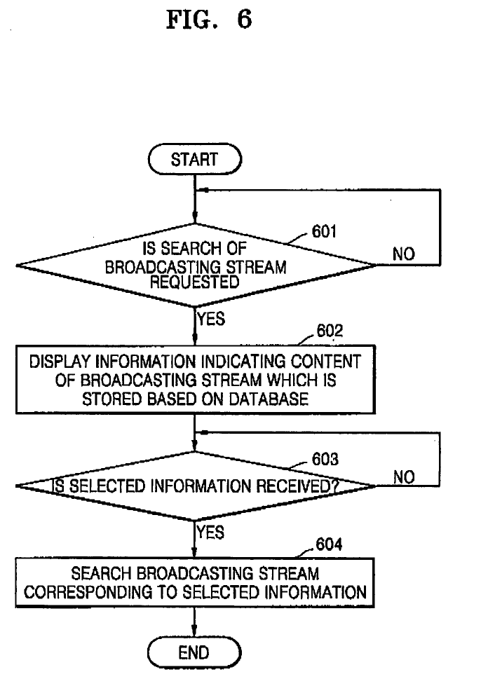

FIG. 6 is a flowchart of a method of a searching broadcasting stream according to an embodiment of the present invention.

When a user requests to search a broadcasting stream to play or manage a stored broadcasting stream (operation 601), the control unit 107 searches the database information stored in the storage medium 106, and displays information indicating a content of the stored broadcasting stream based on the searched database (operation 602). The displayed information indicating the content of the broadcasting stream has the hierarchical data structure as the structure 410 illustrated in FIG. 4. That is, the information indicating the content of the stored broadcasting stream can be displayed as the hierarchical data structure based on the broadcasting type, the storage date, the broadcasting title, the broadcasting station, and/or the size of the stored data.

When information selected on the basis of the displayed information is received (operation 603), the control unit 107 searches a broadcasting stream corresponding to the selected information from the storage medium 106 (operation 604). The searched broadcasting stream can be played or managed according to the user's request. The selected information is generated by the user.

As described above, a database for a broadcasting stream is constructed, the broadcasting stream being stored based on service information indicating a content of the broadcasting stream that is included in a high-speed information channel of the received broadcasting stream. Further, when the stored broadcasting stream is searched, the information indicating the content of the broadcasting stream that is stored based on the constructed database is displayed, thereby easily searching the intended broadcasting stream and efficiently and systematically managing the stored broadcasting stream based on the content.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of storing a broadcasting stream, comprising:
storing a broadcasting stream received during a predetermined period;
extracting information indicating a content of the received broadcasting stream from the received broadcasting stream; and
constructing a database based on the extracted information,
wherein the database includes link information about the stored broadcasting stream.

2. The method of claim 1, wherein the information indicating the content of the broadcasting stream is extracted from a high-speed information channel of transmission frames of the received broadcasting stream.

3. The method of claim 1, wherein the link information includes at least one of a storage path, file name, storage date, or storage location of the broadcasting stream.

4. The method of claim 3, wherein:
the information indicating the content includes at least one of ensemble information, sub channel configuration, basic service and service component configuration, service component language, or a data service label; and
the database has a hierarchical data structure based on the information indicating the content.

5. The method of claim 1, wherein:
the information indicating the content includes at least one of ensemble information, sub channel configuration, basic service and service component configuration, service component language, or a data service label; and
the database has a hierarchical data structure based on the information indicating the content.

6. The method of claim 1, further comprising:
checking whether the extracted information indicating the content is effective; and
constructing the database when the information indicating the content is recognized to be effective.

7. The method of claim 6, further comprising:
attempting to extract the information indicating the content of the broadcasting stream until reaching a predetermined number of attempts or until a predetermined time elapses; and
if the predetermined number of attempts is reached or the predetermined time elapses, the information indicating the content of the broadcasting stream is determined to be not effective.

8. A method of storing and searching a broadcasting stream in a broadcasting receiver, the method comprising:
storing a broadcasting stream during a predetermined period;
extracting information indicating a content of the received broadcasting stream from the received broadcasting stream;
constructing a database based on the extracted information;
displaying the information indicating the content of the stored broadcasting stream based on the database; and
searching a broadcasting stream corresponding to select information from the stored broadcasting stream when the select information, selected on the basis of the information to be displayed, is received,
wherein the database includes link information about the stored broadcasting stream.

9. The method of claim 8, wherein the information indicating the content of the broadcasting stream is extracted from a high-speed information channel of the received broadcasting stream.

10. The method of claim 8, wherein:
the information indicating the content includes at least one of ensemble information, sub channel configuration, basic service and service component configuration, service component language, or a data service label; and
the database has a hierarchical data structure based on the information indicating the content.

11. The method of claim 10, wherein the link information includes at least one of a storage path, file name, storage date, or storage location of the broadcasting stream.

12. The method of claim 10, wherein the information indicating the content of the stored broadcasting stream is displayed as a hierarchical data structure based on at least one of a broadcasting type, a storage date, a broadcasting title, a broadcasting station, or a size of the stored data.

13. The method of claim 8, wherein the information indicating the content of the stored broadcasting stream is displayed as a hierarchical data structure based on at least one of a broadcasting type, a storage date, a broadcasting title, a broadcasting station, or a size of the stored data.

14. An apparatus for storing and searching a broadcasting stream in a broadcasting receiver, the apparatus comprising:
an information extracting unit extracting information from a received broadcasting stream indicating a content of the received broadcasting stream;
a database constructing and searching unit constructing a database based on the extracted information indicating the content of the received broadcasting stream, and searching the constructed database;
a storage medium storing the received broadcasting stream and the constructed database; and
a control unit controlling the constructed database to be stored in the storage medium, controlling the information indicating the content of the broadcasting stream stored in the storage medium to be output based on the database that the database constructing and searching unit searches from the storage medium, and when a searching request signal is received, searching a broadcasting stream corresponding to the received searching request signal from the storage medium,
wherein the database includes link information about the broadcasting stream stored in the storage medium.

15. The apparatus of claim 14, wherein the information extracting unit extracts the information indicating the content of the broadcasting stream from a high-speed information channel of the received broadcasting stream.

16. The apparatus of claim 14, wherein the link information includes at least one of a storage path, file name, storage date, or storage location of the broadcasting stream.

17. The apparatus of claim 16, wherein:
the information indicating the content includes at least one of ensemble information, sub channel configuration, basic service and service component configuration, service component language, or a data service label; and
the database has a hierarchical data structure based on the information indicating the content.

18. The apparatus of claim 16, wherein the output information has a hierarchical data structure based on at least one of a broadcasting type, a storage date, a broadcasting title, or a size of stored data of the stored broadcasting stream.

19. The apparatus of claim 14, wherein:
the information indicating the content includes at least one of ensemble information, sub channel configuration, basic service and service component configuration, service component language, or a data service label; and
the database has a hierarchical data structure based on the information indicating the content.

20. The apparatus of claim 14, wherein the output information has a hierarchical data structure based on at least one of a broadcasting type, a storage date, a broadcasting title, or a size of stored data of the stored broadcasting stream.

21. A broadcasting receiver, comprising:
a user interface;
a channel selecting and receiving unit extracting a digital broadcasting signal of a user selected channel, and outputting a demodulated broadcasting stream by demodulating the extracted digital broadcasting signal and removing a carrier wave therefrom;
a stream analyzing unit classifying the received broadcasting stream according to channels and media when receiving the broadcasting stream of the selected channel from the channel selecting and receiving unit;
a decoder decoding audio, video and/or data information transferred from the stream analyzing unit and transmitting such decoded information to at least one output device;
a storage medium to store the broadcasting stream;
an information extracting unit extracting information indicating a content of the broadcasting stream;
a database constructing and searching unit to construct a database about the broadcasting stream based on the extracted information, to search the database, and to output database information to the user interface, the database also being stored in the storage medium; and
a control unit, to receive signals via the user interface unit and control each component of the digital broadcasting receiver.

22. The broadcasting receiver according to claim 21, wherein controlling each component of the digital broadcasting receiver comprises:
when a signal requesting storage of the broadcasting stream is received from the user interface
controlling the stream analyzing unit to store the intended broadcasting stream in the storage medium, and
controlling the information extracting unit and the database constructing and searching unit to construct the database and store the constructed database in the storage medium; and
when a signal requesting searching of the broadcasting stream is received from the user interface
controlling the storage medium and the database constructing and searching unit to search the database information, and transfer the searched database information to the user interface unit.

23. A method of storing a broadcasting stream, comprising:
determining whether storage of the broadcasting stream is requested;
if storage of the broadcasting stream is requested, extracting information indicating a content of the broadcasting stream;
determining whether the extracted information is effective;
if the extracted information is determined to be effective,
setting link information based on the information indicating the content of the broadcasting stream, and
constructing and storing a database based on the extracted information, and storing the broadcasting stream; and
if the extracted information is determined to not be effective,
performing another attempt to extract the information indicating the content of the broadcasting stream until the extracted information is determined to be effective or a predetermined condition is met, and
if the predetermined condition is met, designating a storage path and file name to store the broadcasting stream.

24. A method, comprising:
receiving a digital broadcasting stream;
constructing a database using information included in the digital broadcasting stream indicating a content of the digital broadcasting stream;
storing the digital broadcasting stream using the information indicating the content of the digital broadcasting stream; and
searching for the stored broadcasting stream using the database.

25. A method, comprising:
receiving a digital broadcasting stream; and
storing the broadcast stream, and storing, in a database, content from the broadcast stream identifying the broadcast stream and link information identifying a storage location of the broadcast stream.

26. The method according to claim 25, further comprising:
allowing a user to search the database content to find the broadcast stream.
